(19) United States
(12) Patent Application Publication
(10) Pub. No.: US 2015/0193740 A1
(43) Pub. Date: Jul. 9, 2015

(54) SYSTEM AND METHOD FOR DISPLAYING A MAIL MESSAGE WITH A MEETING INVITATION

(71) Applicant: GOLDMARK TECHNOLOGIES LTD., REHOVOT (IL)

(72) Inventors: EDDIE NUDEL, REHOVOT (IL); JOHNATHAN EREZ, GIVATAYIM (IL)

(21) Appl. No.: 14/588,941

(22) Filed: Jan. 4, 2015

Related U.S. Application Data
(60) Provisional application No. 61/923,682, filed on Jan. 5, 2014.

(51) Int. Cl. G06Q 10/10; H04L 12/58

(52) U.S. Cl. CPC G06Q 10/1095; H04L 51/046; G06Q 10/107

(57) ABSTRACT

A method including receiving an email message, identifying the received email message as a meeting invitation, detecting a calendar gesture performed by a recipient of the email message, and responsive to the calendar gesture performed on the received email message, automatically displaying a daily agenda of the recipient of the email message inside the received the email message, said daily agenda comprising the date of the meeting invitation and the meeting invitation of the received email and displaying an interface for receiving the recipient's response concerning the meeting invention while displaying the daily agenda.

### CROSS-REFERENCE TO RELATED APPLICATIONS

This application claims the benefit of priority from U.S. Provisional Patent Application No. 61/923,682, filed Jan. 5, 2014, the disclosure of which is incorporated herein by reference in its entirety.

### FIELD OF THE INVENTION

The present invention generally relates to email messages, more specifically to email messages that contain an invitation to a meeting.

### BACKGROUND OF THE INVENTION

One common use of email messaging is invitation to a meeting. The invitation is sent as an email from a meeting organizer to other participants in the meeting. The other participants may reply to the invitation email, for example by accepting, declining or with a textual content.

In mobile email applications, whether native ones (such as iOS clients) or 3^{rd} parties (such as Gmail), the information regarding invitation is limited. Such information can be date, time, location, meeting's title and participants. When such invitation is received in the inbox, existing mobile email applications usually display sender, title and only part of location/date/time data so the user is forced to open the email in order to see all relevant details of the invitation. Furthermore, one of the key factors for deciding whether to accept, decline or send a tentative response is the availability of the recipient, i.e. his daily agenda for the corresponded date. This process requires many actions from the recipient of the invitation only to see basic invitation details, let alone his availability at the time of the meeting and the actions needed to reply accordingly.

### SUMMARY OF THE INVENTION

The present invention provides for a new format of an email message with a meeting invitation and a user interface which enables the recipient of the email message to quickly decide whether he accepts the meeting and respond within a single click. The new format and interface provides all the details of the invitation in the inbox level, i.e. where the list of emails is being displayed, followed by the daily agenda of the user for the corresponded time of the invitation and then the option to respond to the meeting.

It is an object of the subject matter to disclose a method, comprises: receiving an email message; identifying the received email message as a meeting invitation, detecting a calendar gesture performed by a recipient of the email message responsive to the calendar gesture performed on the received email message, automatically displaying a daily agenda of the recipient of the email message inside the received the email message, said daily agenda comprises the date of the meeting invitation and the meeting invitation of the received email and displaying an interface for receiving the recipient's response concerning the meeting invention while displaying the daily agenda.

In some cases, the method also comprises formatting the received email message to include all the relevant invitation data; displaying the formatted meeting invitation in the inbox level.

In some cases, the relevant invitation data comprises date, time, location, sender and invitation title. In some cases, the method further comprises extracting calendar data from a calendar associated with the receiver of the email message. In some cases, the method further comprises detecting a calendar gesture performed by a recipient of the email message. In some cases, the method further comprises displaying, responsive to the calendar gesture, a daily agenda of the recipient of the email message, said daily agenda comprises the invitation of the received email. In some cases, the daily agenda is displayed in the email application.

In some cases, formatted meting invitation comprises a calendar area and a timing area. In some cases, the timing area shows a start time and end time of the meeting and the date of the meeting of the received email message. In some cases, the method further detecting a user's request for navigation data and providing the user with navigation data to the location of the meeting of the received email message. In some cases, the navigation data comprises path to the location of the pending meeting, estimated amount of time from a predefined location to the location of the pending meeting. In some cases, the navigation data comprises an answer that the meeting contradicts with another meeting in the calendar in terms of inability to travel from one meeting to another on time.

It is another object of the subject matter to disclose a system, comprises: an email receiver for receiving an email message; a processor for identifying that the received email message as a meeting invitation; a meeting invitation unit for formatting the received email message to include all the relevant invitation data; a display device for displaying the formatted meeting invitation in the inbox level.

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are designated by the same numerals or letters.

FIG. 1 shows a meeting invitation email message according to exemplary embodiments of the present invention;

FIG. 2 shows a calendar display with the meeting invitation, according to exemplary embodiments of the disclosed subject matter;

FIG. 3 shows a method for handling a meeting invitation in an email message, according to exemplary cases of the subject matter; and,

FIG. 4 shows a system for handling a meeting invitation in an email message, according to exemplary cases of the subject matter.

### DETAILED DESCRIPTION

The present invention provides for a system and method of handling an email message that comprises a meeting invitation. The method comprises identifying that the email comprises an invitation, formatting the email in a unique manner to enable the user to have all relevant meeting data and displaying the formatted email. The formatted message may be displayed on the inbox level or when opening the received email. The formatted message will contain relevant meeting data, such as date, time, location, sender and invitation title (i.e. its subject). The method also enables moving in a single gesture from the display of the formatted message to the user's daily agenda in order to check the user's availability without the need to open another standalone calendar application followed by an option to respond to the invitation, i.e. accept, decline or send a tentative response and with an option to get directions and/or meeting location on the map in one click. The user in the context of the meeting invitation is also the recipient of the meting invitation that uses the mobile email application in order to process the meeting invitation.

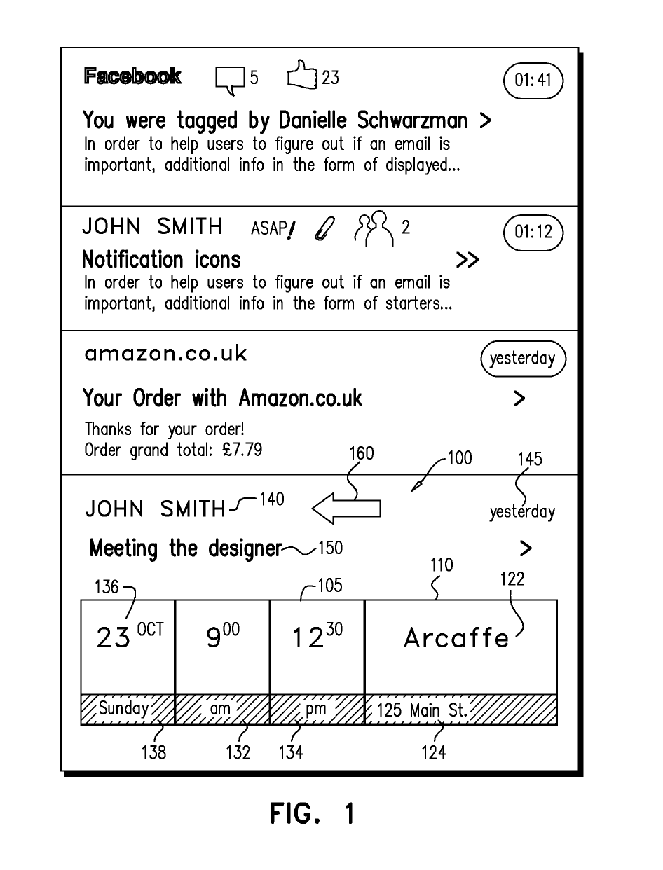

FIG. 1 shows a meeting invitation email message according to exemplary embodiments of the present invention. The meeting invitation email is received in the user's device and is formatted according to predefined rules. The formatting of the email may be performed in a server handling email messages received at the user's device or in the user's device itself.

The formatted email message 100 comprises a timing area 105 comprising start time 132, and end time 134 of the meeting and the date 136 of the meeting. The date 136 can contain month and day or month, day and a year. The timing area 105 may also comprise the day in the week 138 in which the meeting is scheduled. The formatted email message 100 comprises location area 110 which shows the location 122 and the address 124 of the meeting according to data which the meeting organizer inputted. In some exemplary cases, the time area 105 and the location area 110 are displayed in the same row.

The formatted email message 100 also comprises a sender's name or email address 140 and the subject 150 of the meeting, and data regarding the receipt date 145 of the email message. The formatted email message 100 may be displayed in the inbox level or when opening the email message. The formatted email message 100 enables the person receiving the formatted email message 100 to view all the relevant data regarding the invitation without accessing an attached file in which the invitation data is stored or open the email itself.

The formatted message 100 may be handled in manner known in the art, such as sending the formatted message to trash, reply, forward and the like. The user of the email client application may apply a gesture on the formatted message 100 in order to view daily agenda for the date and time of the meeting of the formatted message 100 in order to check his availability using a single gesture without the need to open an external application and track down the corresponded date and time. The gesture may be a swipe gesture 160, in which the user moves his finger or cursor on the formatted message 100 in a lateral manner, for example from right to left. In some exemplary cases, the gesture used to open the calendar from the formatted message 100 of the meeting invitation is different from the gesture used to open standard email operations such as reply, delete and forward.

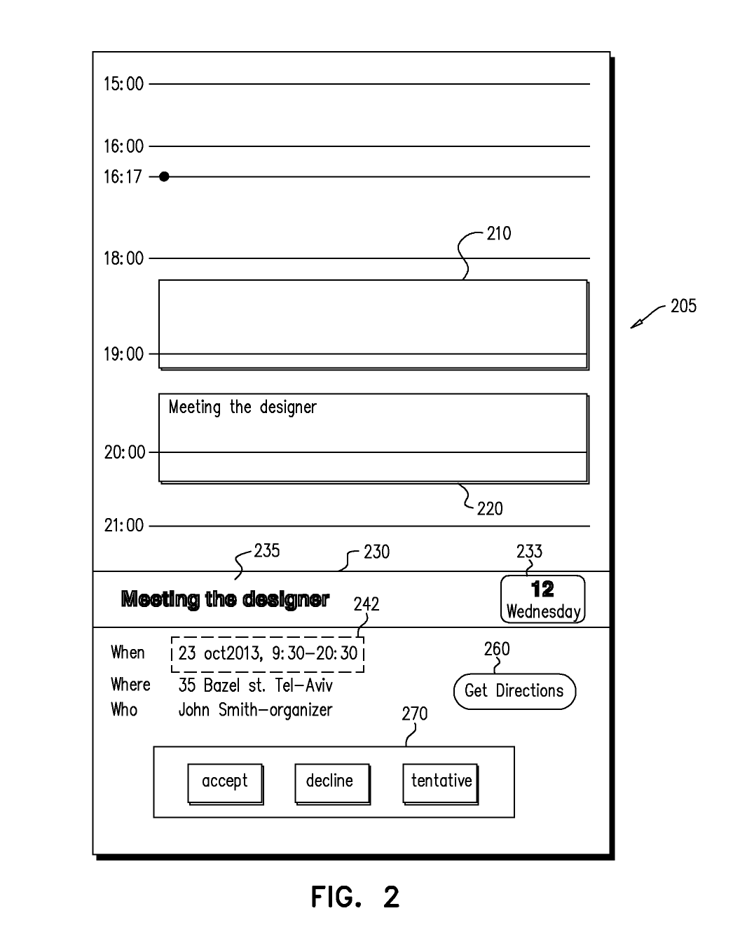

FIG. 2 shows a calendar display with the meeting invitation, according to exemplary embodiments of the disclosed subject matter that was activated by a single gesture of the corresponded initiation in the feed of emails. The calendar display 200 comprises a calendar area 205 that comprises the schedule for a specific day or plurality of days. In the example of FIG. 2, the calendar area 205 comprises a scheduled meeting 210 and a pending meeting 220 associated with the formatted email 100 of FIG. 1, a meeting that the recipient has not yet replied to. The calendar display also comprises a pending meeting information area 230 that comprises data that characterizes the pending meeting 220. The data that characterizes the pending meeting 220 may be subject 235 of the pending meeting, date of receipt of the invitation email 233, extended date information and time 242 comprising start time, end time and date of the pending meeting 220. The pending meeting information area 230 also comprises data regarding the location of the pending meeting 220 and the name of the meeting organizer. The calendar display 200 may also comprise a navigation area 260 in which the user can press in order to receive navigation instruction to the location of the pending meeting 220. The navigation instruction may be important to assist the recipient of the meeting invitation to decide whether he/she is available for the meeting or not. For example, the recipient may input the location of the previous meeting as a source from which he goes to the location of the pending meeting, which is the destination.

The calendar display also comprises a decision area 270, in which the recipient of the formatted message presses in order to decide whether he accepts the invitation, declines or replies as tentative. Moving from the inbox level, in which a formatted email message provides relevant data on the meeting, directly to the calendar and sending a response to the meeting invitation within a single click, provides a quick and efficient interface for a recipient of a meeting.

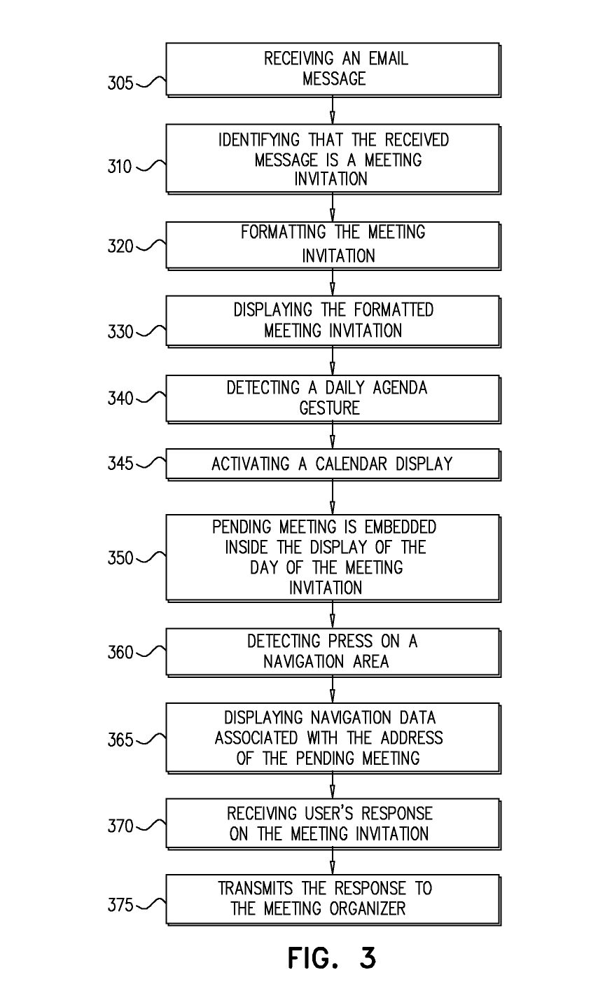

FIG. 3 shows a method for handling a meeting invitation in an email message, according to exemplary cases of the subject matter. The method comprises receiving an email message 305. Receipt of the email message may be performed in a server side or in a client side. The method also comprises identifying that the received message is a meeting invitation 310. The identification may be performed by parsing at least a portion of the email message, a predefined field in the received email, by email type identifier and the like. The identification may be performed by comparing at least a predefined period of the received email message with a known expression. The identification may be performed by compratring at least a portion of the email message, or just the subject of the received email message, to a predefined expression, such as “invitation to a meeting”.

The method also comprises formatting 320 the meeting invitation in a manner that comprises all the relevant meeting data for the user, such that all the relevant meeting data is accessible and viewable to the user without the requirement of an additional action such as opening attached file with invitation details or viewing the email itself by clicking on it in the list of emails screen. The method also comprises displaying the formatted meeting invitation 330 for a recipient of the meeting invitation. Displaying the formatted meeting invitation is performed on the client side of the email application. The email application may display the formatted meeting email on the inbox level as shown in FIG. 1. The email application may display the formatted invitation when viewing the email itself by clicking on it in the list of emails screen.

After the formatted meeting invitation is displayed in a manner that provides the user with all relevant information regarding the meeting, the present invention enables the user of the email application to check if he is available in the date and the time of the corresponded meeting, i.e. if the meeting can take place based on his daily agenda. Checking user's daily agenda (as appears in his calendar in the date of the pending invitation) will be possible by a single click or gesture from the inbox level. Displaying the user's daily agenda may also be possible from the email level, after the recipient opens the received email. The method discloses detecting a daily agenda gesture 340 performed by the user. The daily agenda gesture may be a swipe from left to right on the formatted meeting invitation, or any other action performed on the meeting invitation, for example pointing on a predefined area on the meeting invitation. Upon detection of the daily agenda gesture, the method provides for activating a calendar display 345, for example the calendar associated with the email application used by the recipient of the meeting invitation. The calendar display may show a daily agenda of the date of the pending meeting, two or more days, or a portion of the day of the pending meeting. In some cases, the recipient may define the calendar display in the user's settings, for example how to display the pending meeting and the amount of hours/days to be displayed. In some cases, the user won't need to run an external calendar application (external to the email application) in order to view his daily agenda). The email application extracts the recipient's daily agenda for the date of the pending meeting. Extracting the recipient's daily agenda may be provided from the recipient's email calendar, as in Google accounts or the local calendar in the user's device or the local calendar in the user's email application. In some exemplary cases, more than one day's agenda could be displayed. When the daily agenda is activated, the pending meeting is embedded 350 inside the display of the day of the meeting invitation, as shown in FIG. 2. In some cases, the pending meeting is displayed in a different manner than other items in the daily agenda, for example the pending meeting's color of background is different.

The method may also associate the pending meeting with navigation/location data, which may facilitate the recipient of the meeting invitation to decide how to respond to the meeting invitation. The user may press an icon or an area associated with navigation/location. In such a case, the system of the subject matter detects press on a navigation area 360. Detection of the user's request for navigation data may be performed by detecting the user's voice and recognizing that the user wishes to receive navigation instructions or meeting location associated with the pending meeting. Responsive to detection of the user's interaction with the navigation/location area, the method comprises displaying navigation data associated with the address of the pending meeting 365. The navigation data comprises one or more items from a list of a path to the location of the pending meeting, estimated amount of time from a predefined location to the location of the pending meeting, an answer that the meeting contradicts with another meeting in the calendar in terms of inability to travel from one meeting to another on time, calculating travel time from an address of one meeting in the calendar to another meeting in the calendar, displaying meeting location and the like.

The method also comprises receiving user's response on the meeting invitation 370. The user's response may be “accept”, “decline”, “tentative” or another option suggested by an interface of a meeting invitation as desired by a person skilled in the art. The user's response may be received via pointing on an area associated with a selection, for example in the decision area 270. Once the user's response to the meeting invitation is received, the method of the subject matter transmits the response to the meeting organizer 375, for example via email and updates user's daily agenda accordingly. Such update can take place in user's local calendar app (e.g. Apple Calendar app) and/or his email account (e.g. Google's Calendar)

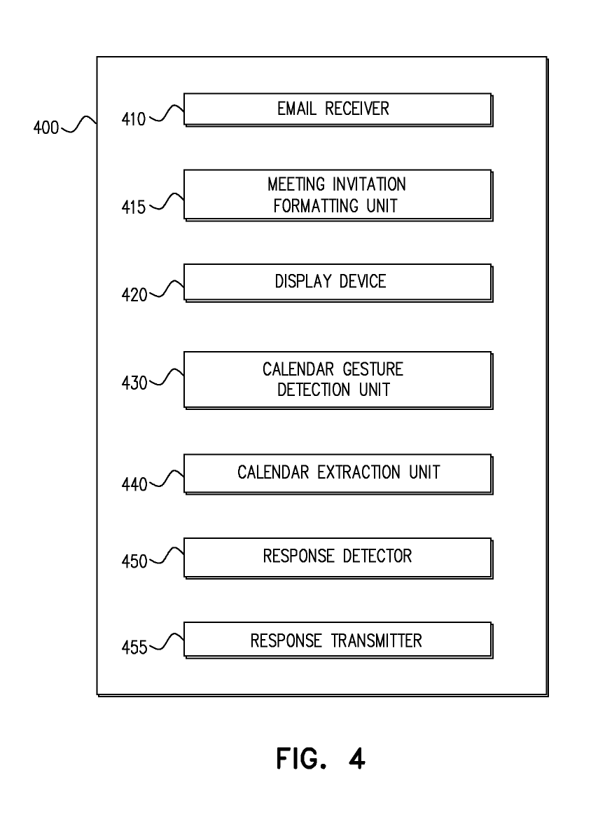

FIG. 4 shows a system for handling a meeting invitation in an email message, according to exemplary cases of the subject matter. The system 400 comprises an email receiver 410 for receiving the email message. The email receiver may reside in the email server or an email application that reside on the user's device. The system also comprises a message formatting unit 415. The message formatting unit 415 extracts data regarding the meeting, for example from an ICS file attached to the received email and formats the email into a formatted email message that comprises the relevant invitation data.

The system may also comprise a display device 420 for displaying the formatted invitation message to the recipient of the meeting invitation. The display device may be a display of a mobile device such as a smart phone or a tablet computer. The display device 420 may be a display device in which a user touches or points in order to manipulate data or perform tasks, such as respond to the meeting invitation or move to the daily agenda. The system of the subject matter may also comprise a calendar gesture detection unit 430 for detecting a gesture by a user of the system that activates a display of the recipient's calendar which is being stored in the system, for example in the email application. The gesture may be a swipe gesture, pointing gesture, tap gesture and the like. The calendar gesture is predefined and rules that define the calendar gesture may be stored in a storage of the system. Upon detection of the calendar gesture by the calendar gesture detection unit 430, the display device displays a portion of the recipient's calendar, that fits the pending invitation, for example a daily agenda from the user's calendar that is extracted by the calendar extraction unit 440. The calendar extraction unit 440 extracts the recipient's calendar, for example from the calendar application in the recipient's mobile device, or from the recipient's email account. The system also comprises a response detector which detects the recipient's response to the meeting invitation, such as accept, decline or others. The response is transmitted to the organizer of the meeting using a response transmission module, for example via an email server.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A method comprising:
receiving an email message;
identifying the received email message as a meeting invitation;
detecting a calendar gesture performed by a recipient of the email message;
responsive to the calendar gesture performed on the received email message, automatically displaying a daily agenda of the recipient of the email message inside the received the email message, said daily agenda comprising the date of the meeting invitation and the meeting invitation of the received email and displaying an interface for receiving the recipient's response concerning the meeting invention while displaying the daily agenda.

2. The method according to claim 1, further comprising formatting the received email message to include all the relevant invitation data.

3. The method according to claim 2, further comprising displaying the formatted meeting invitation in the inbox level.

4. The method according to claim 2, wherein the relevant invitation data comprises date, time, location, sender and invitation title.

5. The method according to claim 1, further comprising extracting calendar data from a calendar associated with the receiver of the email message.

6. The method according to claim 1, wherein the daily agenda is displayed in the email application.

7. The method according to claim 2, wherein the formatted meeting invitation comprises a calendar area and a timing area.

8. The method according to claim 7, wherein the timing area shows a start time and end time of the meeting and the date of the meeting of the received email message.

9. The method according to claim 1, further comprising detecting a user's request for navigation data and providing the user with navigation data to the location of the meeting of the received email message.

10. The method according to claim 1, wherein navigation data comprises path to the location of the pending meeting, estimated amount of time from a predefined location to the location of the pending meeting.

11. The method according to claim 1, wherein navigation data comprises an answer that the meeting contradicts with another meeting in the calendar in terms of inability to travel from one meeting to another on time.

12. A system comprising:
an email receiver for receiving an email message;
a processor for identifying that the received email message as a meeting invitation;
a display device for automatically displaying a daily agenda of the recipient of the email message inside the received email message responsive to a calendar gesture performed on the received email message, said daily agenda comprising the date of the meeting invitation and the meeting invitation of the received email and displaying an interface for receiving the recipient's response concerning the meeting invention while displaying the daily agenda.

13. The system of claim 12, further comprising a meeting invitation unit for formatting the received email message to include all the relevant invitation data.
